(19) United States
(12) Patent Application Publication
(10) Pub. No.: US 2015/0035953 A1
(43) Pub. Date: Feb. 5, 2015

(54) Electronic display numerical aberration correction

(71) Applicant: RealD Inc., Beverly Hills, CA (US)

(72) Inventors: Leo Bredehoft, Longmont, CO (US); Michael G. Robinson, Boulder, CO (US)

(21) Appl. No.: 14/448,098

(22) Filed: Jul. 31, 2014

Related U.S. Application Data
(60) Provisional application No. 61/860,364, filed on Jul. 31, 2013.

(51) Int. Cl. H04N 13/04

(52) U.S. Cl. CPC H04N 13/0484
USPC 348/51

(57) ABSTRACT

Disclosed is a method for stereoscopic numerical aberration compensation. One embodiment of this may be implemented as a software module which may be invoked after the display content has been copied, as in the case of prepared content such as a movie, or rendered, as in the case of dynamically-generated content, such as a game or design visualization application. This scheme windows the image in the frame buffer in-place, as a final processing step prior to transmission to the display. A less-tightly-integrated embodiment modifies the data during transmission, with minimal additional buffering.

### CROSS-REFERENCE TO RELATED APPLICATION

This application relates and claims priority to commonly-assigned U.S. Provisional Patent Application No. 61/860,364, filed Jul. 31, 2013, entitled “Electronic display numerical aberration correction system and method thereof,” (Attorney Ref. No.: 95194936.359000), which is herein incorporated by reference in its entirety.

### TECHNICAL FIELD

This disclosure generally relates to optical and display systems, and more specifically relates to optical and display systems for use in 2D and 3D display.

### BACKGROUND

The increasing prevalence of the use of digital imaging in optical systems makes codesign of image processing algorithms and optics an alternative in the quest for improvement in performance and enrichment of feature sets of imaging devices. This is especially true as computational power incorporated into these systems becomes cheaper and more readily available. In the case of electronic display systems, there are specific computational optimization opportunities which may be exploited to improve the systems' quality and performance.

### BRIEF SUMMARY

According to a first aspect of the present disclosure, a method for compensating for aberrations in a display may include receiving image capture data, estimating at least one eye position from at least the image capture data, windowing the image data to produce compensated display data by employing the at least one eye position and database information. The compensated display data may correct for aberrations that vary with viewing location. Then compensated display data may be provided to a display device. The image data may be stereoscopic image data or two dimensional image data. Windowing image data may include receiving the database information from a table. The image data may be dynamically generated display content or prepared display content. Windowing image data may also include receiving the database information from a table and the table may include radiation models. Also, correction coefficients may be computed using the radiation models and the radiation models may be polynomials. The method may further include interpolating the table entries to produce off-sample correction coefficients. The database information from the table may also include correction coefficients. Windowing the image data may also include multiplying display information by the table coefficients to adjust the display information.

According to another aspect of the present disclosure, a display system for correcting aberrations may include a display, an eye tracking system that may receive viewer information from a camera and may provide at least an eye position estimate. The display system may include a windowing system that may receive the at least an eye position estimate from the eye tracking system, and the windowing system may provide corrected display information to a display. The corrected display information may be stereoscopic display information. The display system may also include a frame buffer system that may receive an image source and that may provide information to the windowing system and a calibration database that may provide information to the windowing system. The display system may additionally include a beam steering logic system that may receive at least an eye position estimate from the eye tracking system and the beam steering logic system may provide steering commands to the display. In the case the image source is dynamically generated, the calibration database may include radiation models. The image source may be prepared video content and in the case of prepared video content, the calibration database may include correction coefficients that may correct positional aberrations that vary with viewing locations. The radiation models may be polynomials.

According to another aspect of the present disclosure, a method for compensating aberrations in a display may include rendering a generated object to produce a first bitmap, computing angles using at least a first eye position, computing an intensity, to produce a second bitmap for correcting aberrations on a display that vary with viewing locations, by using at least the first eye position and the computed angles, and generating corrected display data by employing the first bitmap and the second bitmap.

These and other advantages and features of the present disclosure will become apparent to those of ordinary skill in the art upon reading this disclosure in its entirety.

### BRIEF DESCRIPTION OF THE DRAWINGS

Embodiments are illustrated by way of example in the accompanying FIGURES, in which like reference numbers indicate similar parts, and in which:

FIG. 1 is a schematic diagram illustrating one embodiment of a steered focus stereoscopic display, in accordance with the present disclosure;

FIGS. 2A-2C are schematic diagrams illustrating one embodiment of an isotropic color and/or intensity aberration, in accordance with the present disclosure;

FIGS. 3A-3C are schematic diagrams illustrating one embodiment of an anisotropic color and/or intensity aberration, in accordance with the present disclosure;

FIG. 4 is a schematic diagram illustrating one embodiment of a stereoscopic numerical aberration compensation system, in accordance with the present disclosure;

FIG. 5 is a schematic diagram illustrating one embodiment of stereoscopic crosstalk, in accordance with the present disclosure;

FIG. 6 is a schematic diagram illustrating one embodiment of non-stereoscopic numerical aberration compensation, in accordance with the present disclosure; and

FIG. 7 is a flow diagram of numerical aberration compensation, in accordance with the present disclosure.

### DETAILED DESCRIPTION

According to a first aspect of the present disclosure, a method for compensating for aberrations in a display may include receiving image capture data, estimating at least one eye position from at least the image capture data, windowing the image data to produce compensated display data by employing the at least one eye position and database information. The compensated display data may correct for aberrations that vary with viewing location. Then compensated display data may be provided to a display device. The image data may be stereoscopic image data or two dimensional image data. Windowing image data may include receiving the database information from a table. The image data may be dynamically generated display content or prepared display content. Windowing image data may also include receiving the database information from a table and the table may include radiation models. Also, correction coefficients may be computed using the radiation models and the radiation models may be polynomials. The method may further include interpolating the table entries to produce off-sample correction coefficients. The database information from the table may also include correction coefficients. Windowing the image data may also include multiplying display information by the table coefficients to adjust the display information.

According to another aspect of the present disclosure, a display system for correcting aberrations may include a display, an eye tracking system that may receive viewer information from a camera and may provide at least an eye position estimate. The display system may include a windowing system that may receive the at least an eye position estimate from the eye tracking system, and the windowing system may provide corrected display information to a display. The corrected display information may be stereoscopic display information. The display system may also include a frame buffer system that may receive an image source and that may provide information to the windowing system and a calibration database that may provide information to the windowing system. The display system may additionally include a beam steering logic system that may receive at least an eye position estimate from the eye tracking system and the beam steering logic system may provide steering commands to the display. In the case the image source is dynamically generated, the calibration database may include radiation models. The image source may be prepared video content and in the case of prepared video content, the calibration database may include correction coefficients that may correct positional aberrations that vary with viewing locations. The radiation models may be polynomials.

According to another aspect of the present disclosure, a method for compensating aberrations in a display may include rendering a generated object to produce a first bitmap, computing angles using at least a first eye position, computing an intensity, to produce a second bitmap for correcting aberrations on a display that vary with viewing locations, by using at least the first eye position and the computed angles, and generating corrected display data by employing the first bitmap and the second bitmap.

The increasing prevalence of the use of digital imaging in optical systems makes codesign of image processing algorithms and optics an alternative in the quest for improvement in performance and enrichment of feature sets of imaging devices. This is especially true as computational power incorporated into these systems becomes cheaper and more readily available. In the case of electronic display systems, there are specific computational optimization opportunities which may be exploited to improve the quality and performance of the system.

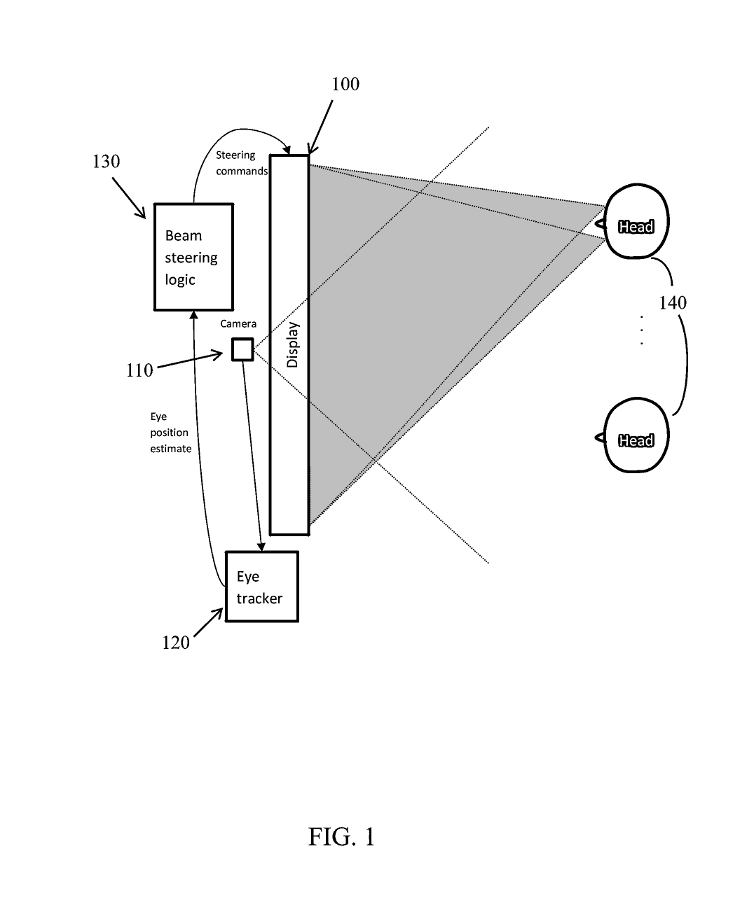

As an example, steered-focus stereoscopic display systems, as shown in FIG. 1, use a camera and eye tracking software to locate and steer the illumination focus to the observer's eyes. FIG. 1 is a schematic diagram illustrating one embodiment of a steered focus stereoscopic display. FIG. 1 includes a display 100, a camera 110, an eye tracking system 120, a beam steering logic system 130, and viewers 140. Although two viewers are illustrated in this embodiment, one or more viewers may view this embodiment. Additionally, although this system is depicted as a stereoscopic display system, the display systems described herein may be two dimensional or three dimensional display systems.

The camera 110 of FIG. 1 may provide information to the eye tracking system 120. The camera may provide information including, but not limited to, video information of the viewer location, eye location of the viewer, number of viewers, any combination thereof and so forth. The eye tracking system 120 may be able to determine the location of the eyes and track movement of the eyes of one or more viewers watching the display. As FIG. 1 indicates, more than one pair of eyes may be tracked. The eye tracking system 120 may then provide information to the beam steering logic system 130. The information provided by the eye tracking system to the beam steering logic system 130, may be an estimate of the eye position of one or more viewers. The beam steering logic system 130 may then provide steering commands to the display 100. The display may then provide the viewing information so that the one or more viewers may view the images on the display.

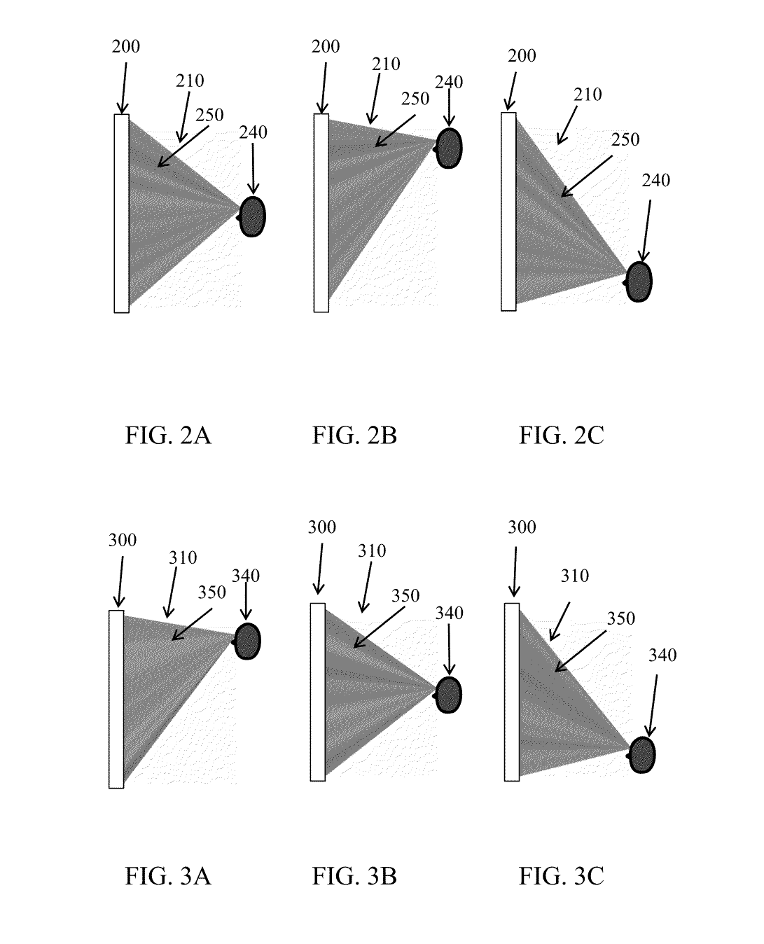

Steering optics may suffer from aberrations in the form of color modulation or intensity modulation as a function of azimuth and elevation angles, as shown for the right eye azimuth angle in FIGS. 2A-2C and FIGS. 3A-3C. FIGS. 2A-2C are schematic diagrams illustrating one embodiment of an isotropic color and/or intensity aberration, and FIGS. 3A-3C are schematic diagrams illustrating one embodiment of an anisotropic color and/or intensity aberration.

FIGS. 2A-2C illustrate the case in which the intensity error at a given viewer location with respect to the display is independent of angle of observation, and FIGS. 3A-3C illustrate the case in which the error varies with angle of observation between the viewer and the display. Both cases can occur for steered-focus stereoscopic displays. FIGS. 2A-2C include a display 200, an intensity profile 210, and a viewer 240 located in three different positions relative to the display 200. In FIG. 2A, the viewer 240 is located in an approximately central location relative to the display 200. The intensity variation of FIG. 2A, illustrates a higher intensity image that is skewed to the right position 250 relative to the viewing position of the viewer 240. In FIG. 2B, the viewer 240 is located in approximately to the right, relative to the display 200. The intensity variation of FIG. 2B illustrates a higher intensity image that is still skewed to the right position 250 relative to the viewing position of the viewer 240. In FIG. 2C, the viewer 240 is located approximately to the left, relative to the display 200. The intensity variation of FIG. 2C illustrates a higher intensity image that is still skewed to the right position 250 relative to the viewing position of the viewer 240. As previously discussed, the intensity error at a given viewer location with respect to the display is independent of angle of observation.

FIGS. 3A-3C illustrate the case in which the error varies with angle of observation between the viewer and the display. FIGS. 3A-3C include a display 300, an intensity profile 310, and a viewer 340 located in three different positions relative to the display 300. In FIG. 3A, the viewer 340 is located approximately to the right relative to the display 300, in FIG. 3B, the viewer 340 is located in an approximately central location relative to the display 300, and in FIG. 3C, the viewer 340 is located approximately to the left relative to the display 300. The intensity variation 340 of FIG. 3A, illustrates a higher intensity image that is skewed depending on the position of the viewer 340 relative to the display 300. Stated differently, depending on the location of the viewer, the aberrations in the viewed image may change according to the viewer location.

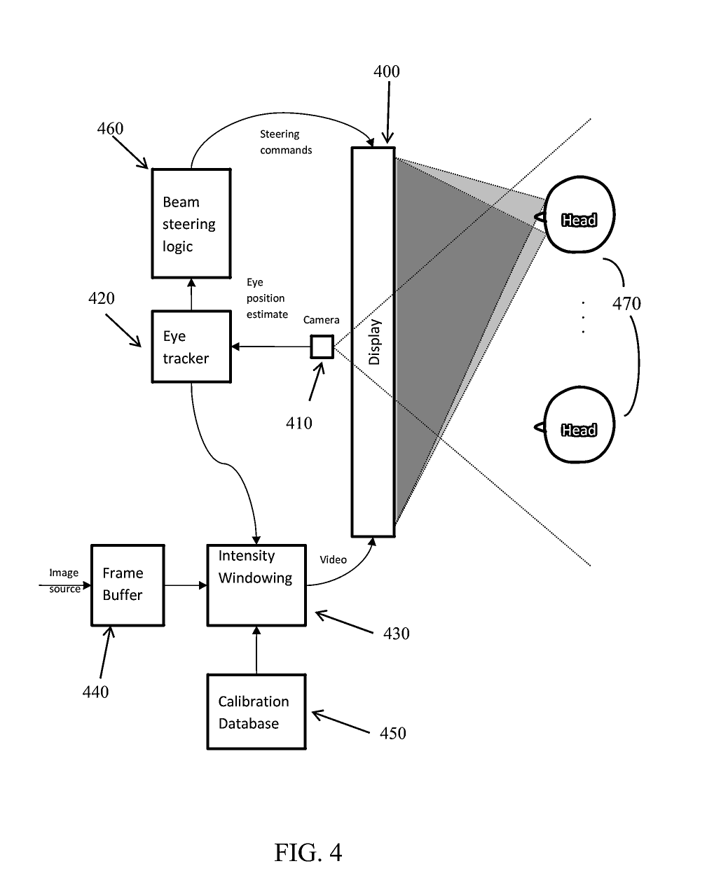

By inserting a color/intensity windowing device between the frame buffer holding the next image for display and the video stream to the display. As shown in FIG. 4, it is possible to substantially reduce or eliminate both forms of aberrations previously discussed. FIG. 4 is a schematic diagram illustrating one embodiment of a stereoscopic numerical aberration compensation system.

FIG. 4 includes a display 400, a camera 410, an eye tracking system 420, an intensity windowing system 430, a frame buffer system 440, a calibration database 450, a beam steering logic system 460, and viewers 470. The term “system” as used herein, is used for discussion purposes only and may be a software module. Similar to FIG. 1, there may be one or more viewers viewing images on the display 400. The camera 410 may provide information including, but not limited to, video information of the viewer location or viewer location relative to the display, viewer location, number of viewers, any combination thereof and so forth. The eye tracking system 420 may be able to determine the location of the eyes and track movement of the eyes of the one or more viewers watching the display. The angle over which the camera 410 may gather or record information may vary depending on the camera. The eye tracking system 420 may then provide an estimation of the eye position of the one or more viewers to the beam steering logic system 460. The intensity windowing system 430 may receive information from at least the eye tracking system 420, the frame buffer system 440, and the calibration database 450. The eye tracking system 420 may receive information from the camera 410. The beam steering logic system 460 may then provide steering commands to the display 400 and the intensity windowing system 430 may also provide information back to the display 400. Beam steering may be achieved using different types of backlighting systems, as generally discussed in, U.S. patent application Ser. No. 13/300,293, “Directional Backlight”, filed Nov. 18, 2011, (RealD Ref. No.: 95194936.281001). In the embodiment of FIG. 4, the images provided by the display may correct the aberrations previously discussed with reference to FIGS. 2A-2C and FIGS. 3A-3C.

One embodiment of this may be implemented as a software module which may be invoked after the display content has been copied, as in the case of prepared content such as a movie, or rendered, as in the case of dynamically-generated content, such as a game or design visualization application. This scheme windows the image in the frame buffer in-place, as a final processing step prior to transmission to the display. A less-tightly-integrated embodiment modifies the data during transmission, with minimal additional buffering.

The calibration database shown in FIG. 4 may be, in the isotropic case, a table whose entries contain the coefficients by which to directly multiply pixel colors to correct intensity. In the anisotropic case, the table entries may be expanded to contain compact radiation models, from which the appropriate correction coefficients may be computed. The systems performing the computations will be discussed herein. The correction coefficients may take the form of polynomials, radiation vectors or any other appropriate model or combination thereof. The storage and computational cost of anisotropic correction may be higher than that of isotropic correction. Under the assumption that the color and intensity aberration varies slowly with observation angle, the table may be decimated and interpolated to produce off-sample coefficients.

The correction step may be performed either under the control of the application supplying the content, or, preferably, the operating system itself. Operating system control may be employed to make application modification unnecessary in order to perform correction.

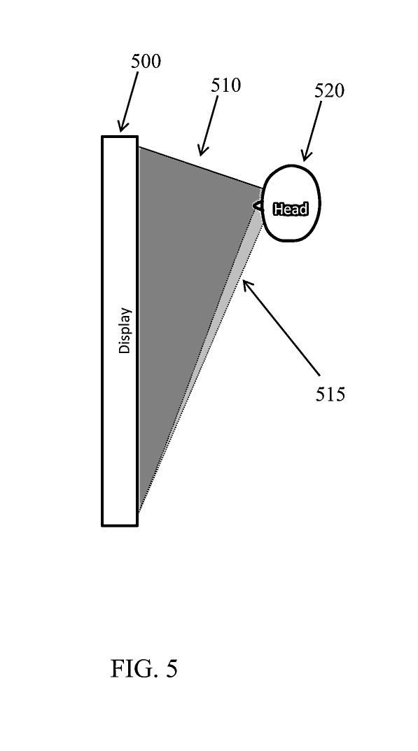

FIG. 5 is a schematic diagram illustrating one embodiment of stereoscopic crosstalk. FIG. 5 depicts unwanted optical crosstalk in a stereoscopic display in which due to low LCD panel speed or optical defects, light steered to one eye inadvertently illuminates the other eye, causing ghosting or other problems. FIG. 5 includes a display 500, viewing information intended for the right eye of the viewer 510, viewing information intended for the left eye of the viewer 515, and the viewer 520. As shown in FIG. 5, the viewing information intended for the left eye of the viewer 515 may unintentionally leak over to the right eye of the viewer causing crosstalk. Crosstalk due to slow panels is often addressed using compensation methods which depend only on the values of a given pixel in both eyes, assuming uniform crosstalk behavior in the panel, independent of pixel location and viewing angle. However, where the amount of crosstalk is also a function of viewer location and pixel location, such compensation methods are not in general applicable

The embodiments discussed herein may also be used to correct for crosstalk which may be a function of position and viewing angle, in addition to crosstalk caused by slow panels. The methods used may directly use linear compensation between corresponding eye images, and it may also include spatial methods to locally increase pixel value headroom or footroom, as described in U.S. patent application Ser. No. 12/541,892, Enhanced ghost compensation for stereoscopic imagery, which is herein incorporated by reference in its entirety.

A standard 1920×1080 monitor running at an update rate of 60 Hz for each eye has a

$$maximum permitted correction computation kernal time of \frac{d}{1920 \cdot 1800 pixels \cdot 2 \cdot eyes \cdot 60 Hz} = 4 d sec ,$$

assuming a decimation factor d. The correction sequence may be arranged arbitrarily, permitting left-to-right, top-to-bottom order, which generally allows maximally-efficient access of pixel memory, since the pixels are generally arranged in this order. Table memory accesses are less efficient because of the sparser access pattern caused by the angular scan and the entry skipping it necessitates. Assuming a full pixel burst fetch and store and ¼-efficiency table reads, the memory bandwidth employed for correction with n 16-bit parameters/pixel may be

$$1920 \cdot 1080 pixels \cdot 2 eyes \cdot 60 Hz \cdot ( 3 \frac{B}{pixel} \cdot 2 accesses + \frac{1}{d} \cdot 4 \cdot n \frac{prm}{pixel} \cdot 2 \frac{B}{prm} ) = ( 1.493 + 1.991 \frac{n}{d} ) \frac{GB}{sec} .$$

Table 1 shows estimated computational and memory bandwidth loads, assuming decimation by a factor of 16, use of 10 parameters for an anisotropic correction and a 100-instruction kernel including DirectX Vector4/OpenGL vec4 multiplies. Instruction issue rates in the table for the nVIDIA and Intel GPU's may be estimated from the ATI rate.

TABLE 1
GPU Load, d = 16, n = 10

| | | | | Memory | | |
|---|---|---|---|---|---|---|
| | Shader | Core clock, | Vector4 issue | Bandwidth, | Computational | Bandwidth |
| GPU | threads | Mhz | rate, MIPS | GB/s | Load, % | Load, % |
| nVIDIA Fermi GeForce GTX690 | 3072 | 0.915 | 435 | 192.3 | 0.19 | 1.42 |
| ATI Radeon HD7970 GHz Edition | 2048 | 0.925 | 440 | 132.0 | 0.28 | 2.07 |
| Intel Core i7-3520M integral GPU | 128 | 0.650 | 309 | 25.6 | 6.29 | 10.69 |

The load figures in Table 1 indicate that the GPU computational capacity and memory bandwidth may support numerical aberration correction for mobile as well as desktop applications.

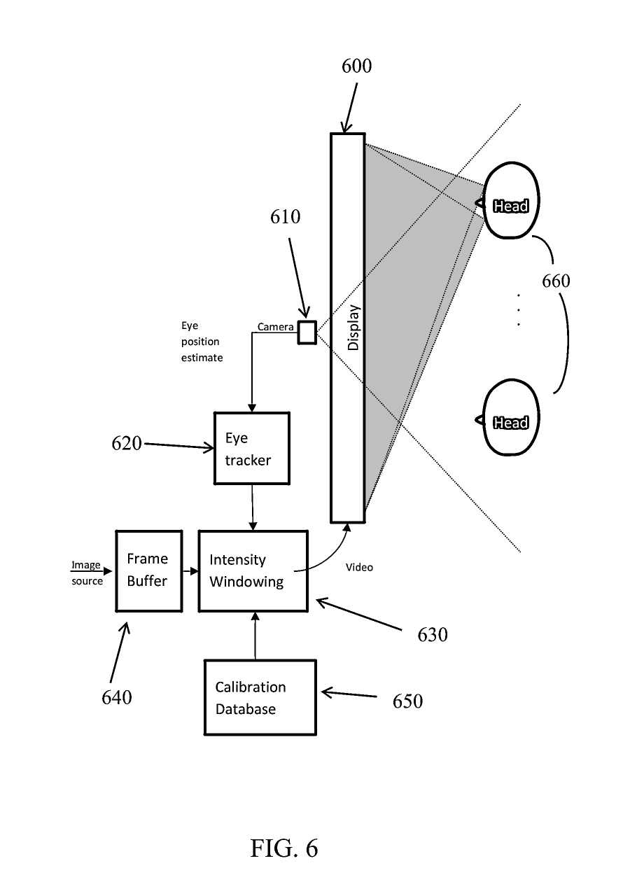

This correction technique is also applicable to non-stereoscopic applications, as shown in FIG. 6. FIG. 6 is a schematic diagram illustrating one embodiment of non-stereoscopic numerical aberration compensation. FIG. 6 includes a display 600, a camera 610, an eye tracking system 620, an intensity windowing system 630, a frame buffer system 640, a calibration database 650, and viewers 660.

Similar to FIG. 4, there may be one or more viewers viewing images on the display 600. The intensity windowing system 630 may receive information from at least the eye tracking system 620, the frame buffer system 640, and the calibration database 650. The eye tracking system 620 may receive information from the camera 610. The camera 610 may provide information including, but not limited to, video information of the viewer location, eye location of the viewer, number of viewers, any combination thereof and so forth. The eye tracking system 620 may be able to determine the location of the eyes and track movement of the eyes of the one or more viewers watching the display. The angle over which the camera 610 may gather or record information may vary depending on the camera. The eye tracking system 620 may then provide an estimation of the eye position of the one or more viewers to the intensity windowing system 630. The intensity windowing system 630 may then provide video information back to the display 600.

Initially, this scheme may be tested by incorporating it in a simple application which displays a flat field, and evaluating that field for uniformity as a function of eye position. The scheme may be tested with actual content by first selecting two applications for which the source code is available, such as, but not limited to, a media player application which displays DVD or file content, and an application which generates live content, such as a game or animated modeling program. Each of the applications would be modified to call the aberration correction code immediately before calling the frame buffer swap entry point to the API.

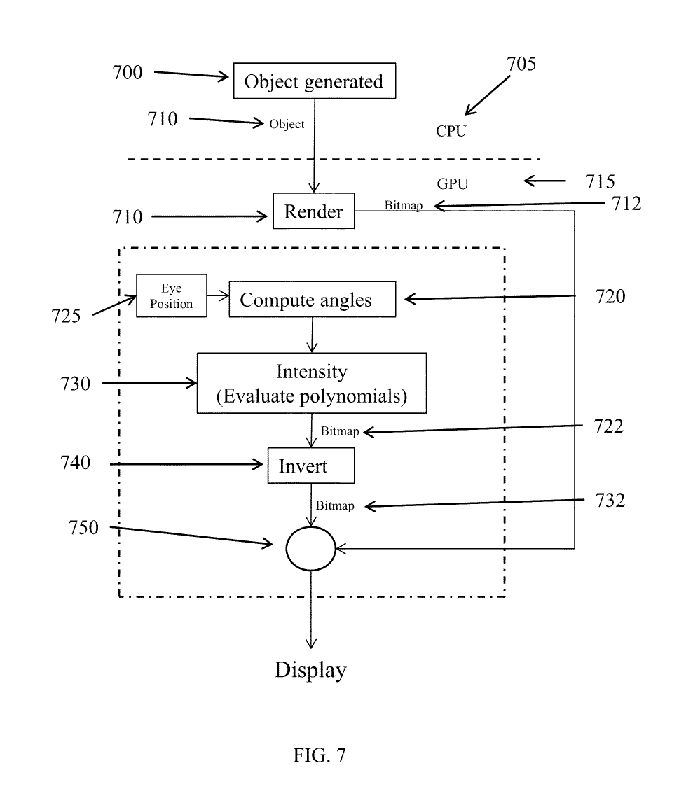

FIG. 7 is a flow diagram of numerical aberration compensation. FIG. 7 is a method in which an object may be generated as illustrated in the first step of the flow diagram of FIG. 7, which will be discussed in further detail below. This object generating step 700 may take place, for example, in a CPU 705. The generated object may be passed from the object generating system in the CPU 705 to the rendering system to the rendering system in the GPU 715. The generated object 702 may then be rendered during a rendering step 710 and produce a first bitmap 712.

The method may then compute angles as shown in step 720. In step 720, one or more eye positions 725 may also be factored into the computation of angles. Next, in step 730, the pixel intensity may be calculated. One way in which the pixel intensity may be calculated is by evaluating polynomials. Step 730 may produce a second bitmap 722. The second bitmap 722 may be inverted at the next step 740, which may provide a third bitmap 732. The third bitmap 732 and the first bitmap 712 may be provided to the step 750 which may use at least the first and third bitmaps to produce a radiation model to the display. In another similar embodiment, the third bitmap may be interpolated before being provided to the step 750 for final processing.

In one example, image samples for generating a radiation model may be taken from a display with a camera or any other appropriate image capturing device. The image samples or pictures may be taken in a plane approximately parallel to the display, for example, planes in the approximately horizontal and vertical direction, and also in the z-direction, in which the z-direction is the direction moving away from or towards the screen or display in an approximately orthogonal direction. A radiation model may be built from the image samples. These image samples or objects may be generated in a CPU. The objects may be rendered and produce a bitmap.

Next, a polynomial, such as a bivariate polynomial may be placed on ‘pixels’ on the screen (in which the ‘pixels’ may be larger than the physical pixels of the display) in elevation and azimuth. Each location of the screen may be associated with a bivariate polynomial and then the radiation pattern coming off of the screen may be modeled. Stated differently, a radiation pattern as a function of at least two angles with respect to the normal to the screen, may come off of the screen and may be produced as a radiation model. Thus, a radiation model for the display may be built. Using the radiation model and the one or more locations of the eyes, a computation may be performed by employing the various polynomials associated with the screen, and produce what a user may view in a given spot on the screen. Next, this information may be inverted or may be stored already inverted as a part of the polynomial or a radiation function, and then an inversion function by which you multiply the display may be computed to correct the aberrations.

Thus, dynamically and in one embodiment, as a function of the location of the eyes of one or more viewers, a radiation model for a display may be computed and inverted, multiplied by the screen values, and thus correct the aberrations by modulating the display.

Embodiments of the present disclosure may be used in a variety of optical systems. The embodiment may include or work with a variety of projectors, projection systems, optical components, displays, handheld displays, cell phones, tablets, phablets, notebooks, microdisplays, computer systems, processors, self-contained projector systems, visual and/or audiovisual systems and electrical and/or optical devices. Aspects of the present disclosure may be used with practically any apparatus related to optical and electrical devices, optical systems, presentation systems or any apparatus that may contain any type of optical system. Accordingly, embodiments of the present disclosure may be employed in optical systems, devices used in visual and/or optical presentations, visual peripherals and so on and in a number of computing environments.

It should be understood that the disclosure is not limited in its application or creation to the details of the particular arrangements shown, because the disclosure is capable of other embodiments. Moreover, aspects of the disclosure may be set forth in different combinations and arrangements to define embodiments unique in their own right. Also, the terminology used herein is for the purpose of description and not of limitation.

The various aspects of the present disclosure and the various features thereof may be applied together in any combination.

As may be used herein, the terms “substantially” and “approximately” provide an industry-accepted tolerance for its corresponding term and/or relativity between items. Such an industry-accepted tolerance ranges from zero percent to ten percent and corresponds to, but is not limited to, component values, angles, et cetera. Such relativity between items ranges between approximately zero percent to ten percent.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the embodiment(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

1. A method for compensating for aberrations in a display, comprising:
receiving image capture data;
estimating at least one eye position from at least the image capture data;
windowing image data to produce compensated display data by employing the at least one eye position and database information, wherein the compensated display data corrects for aberrations that vary with viewing location; and
providing the compensated display data to a display device.

2. The method for compensating for aberrations in a display of claim 1, wherein the image data is stereoscopic image data.

3. The method for compensating for aberrations in a display of claim 1, wherein windowing image data further comprises, receiving the database information from a table.

4. The method for compensating for aberrations in a display of claim 1, wherein the image data further comprises dynamically generated display content.

5. The method for compensating for aberrations in a display of claim 1, wherein the image data further comprises prepared display content.

6. The method for compensating for aberrations in a display of claim 4, wherein windowing image data further comprises, receiving the database information from a table, wherein the table further comprises radiation models.

7. The method for compensating for aberrations in a display of claim 6, further comprising computing the correction coefficients using the radiation models.

8. The method for compensating for aberrations in a display of claim 7, wherein the radiation models are polynomials.

9. The method for compensating for aberrations in a display of claim 8, further comprising interpolating the table entries to produce off-sample correction coefficients.

10. The method for compensating for aberrations in a display of claim 5, wherein the database information from the table further comprises correction coefficients.

11. The method for compensating for aberrations in a display of claim 10, wherein windowing image data further comprises multiplying display information by the table coefficients to adjust the display information.

12. A display system for correcting aberrations, comprising:
a display;
an eye tracking system that receives viewer information from a camera and provides at least an eye position estimate;
a windowing system that receives the at least an eye position estimate from the eye tracking system, wherein the windowing system provides corrected video information to a display.

13. The display system for correcting aberrations of claim 12, wherein the display further comprises a stereoscopic display.

14. The display system for correcting aberrations of claim 12, further comprising a frame buffer system that receives an image source and that provides information to the windowing system.

15. The display system for correcting aberrations of claim 12, further comprising a calibration database that provides information to the windowing system.

16. The display system for correcting aberrations of claim 13, further comprising a beam steering logic system that receives at least an eye position estimate from the eye tracking system and that provides steering commands to the display.

17. The display system for correcting aberrations of claim 15, wherein the calibration database further comprises radiation models.

18. The display system for correcting aberrations of claim 14, wherein the image source is prepared video content and the calibration database comprises correction coefficients that correct positional aberrations that vary with viewing locations.

19. The display system for correcting aberrations for claim 17, wherein the radiation models further comprise polynomials.

20. A method for compensating for aberrations in a display, comprising:
rendering a generated object to produce a first bitmap;
computing angles using at least a first eye position;
computing an intensity, to produce a second bitmap for correcting aberrations on a display that vary with viewing locations, by using at least the first eye position and the computed angles; and
generating corrected display data by employing the first bitmap and the second bitmap.
